(19) United States
(12) Patent Application Publication
(10) Pub. No.: US 2019/0063521 A1
(43) Pub. Date: Feb. 28, 2019

(54) FROZEN BRAKE ROTOR REMOVAL TOOL

(71) Applicant: Norman Bowers, III, Falling Waters, WV (US)

(72) Inventor: Norman Bowers, III, Falling Waters, WV (US)

(21) Appl. No.: 15/687,507

(22) Filed: Aug. 27, 2017

(51) Int. Cl. F16D 65/00; B25B 27/02; B25B 27/00

(52) U.S. Cl. CPC F16D 65/0043; B25B 27/0035; B25B 27/023

(57) ABSTRACT

A tool for removing a brake rotor frozen to a wheel hub includes a right-angled bar having one end configured to rest against a stationary support bracket for a caliper with the caliper and a caliper bracket removed from the stationary support bracket, and an elongated bolt threaded through an opposite end of the right-angled bar to support the elongated bolt laterally offset from the right-angled bar and adjustably turnable relative to the opposite end of the right-angled bar to advance a leading end of the elongated bolt away from the opposite end of the right-angled bar in a direction away from the stationary support bracket toward the brake rotor so as to apply a force between the stationary support bracket and the brake rotor that pushes the brake rotor to separate from the wheel hub.

### BACKGROUND OF THE INVENTION

### 1. Field of the Invention

The present general inventive concept relates generally to automotive wheel brake maintenance and, more particularly, to a frozen brake rotor removal tool.

### 2. Description of the Related Art

Brake rotors are important components in an automotive braking system that prevents wheels on an automobile from spinning as the operator brings the automobile to a stop. However, due to cold weather conditions as a result of chemicals being used excessively on the roads brake rotors may freeze onto the wheel hubs, requiring removal of the brake rotors. Also, in addition to cold weather conditions, concentrations of salt-like chemicals in the atmosphere that surround coast lines and on highways may cause brake rotors to become frozen to wheel hubs by accelerated corrosive processes acting on metals of the braking system components. The removal of a brake rotor also is a result of older vehicles that have had corrosion build-up.

Brake rotor removal is a task that many find difficult and time-consuming. It may take hours using a welder or a torch with high heat output or a heavy hammer to separate the brake rotor from the wheel hub. Also, pounding on the wheel rotor with a heavy hammer may cause damage to the rotor and other parts in the area. Furthermore, not everyone has a welder or torch in their garage. Therefore, typically the automobile would have to be taken to a repair facility for removal of the brake rotor. However, the braking system of the automobile may already be disassembled down to the brake rotor that needs to be removed, so the automobile is likely unable to be taken to the repair garage for the purpose of removing the brake rotor.

Therefore, a need arises for an approach to enable removal of the brake rotor from the wheel hub without using the automobile to drive to a repair shop or resorting to techniques that might damage the rotor and possibly other parts.

### SUMMARY

The present general inventive concept provides a frozen brake rotor removal tool.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a tool for removing a brake rotor frozen to a wheel hub. The frozen brake rotor removal tool may include a right-angled bar having one end configured to rest against a stationary support bracket for a caliper with the caliper removed from the stationary support bracket, and an elongated bolt threaded through an opposite end of the right-angled bar to support the elongated bolt laterally offset from the right-angled bar and adjustably turnable relative to the opposite end of the right-angled bar to advance a leading end of the elongated bolt away from the opposite end of the right-angled bar in a direction away from the stationary support bracket toward the brake rotor so as to apply a force between the stationary support bracket and the brake rotor that pushes the brake rotor to separate from the wheel hub.

The right-angled bar of the tool may have an elongated main portion and an end portion shorter than the elongated main portion and rigidly affixed to and extending in a transverse relationship in one direction away from a first end of the elongated main portion at the opposite end of the right-angled bar.

The right-angled bar of the tool also may have a plate rigidly affixed to and extending in a transverse relationship in another direction opposite to the one direction and away from a second end of the elongated main portion at the one end of the right-angled bar, the plate being configured to rest against the stationary support bracket.

The end portion of the right-angled bar of the tool at an end thereof spaced from the first end of the elongated main portion of the right-angled bar may have a threaded hole formed therethrough that threadably receives the elongated bolt.

The elongated bolt of the tool may have an elongated threaded stem portion and a head portion rigidly affixed to one end of the elongated threaded stem portion that receives a head of a wrench used to turn the elongated bolt.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a side view of a frozen brake rotor removal tool, according to an exemplary embodiment of the present general inventive concept; and

FIG. 2 is a front view of the frozen brake removal tool, according to an exemplary embodiment of the present general inventive concept.

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

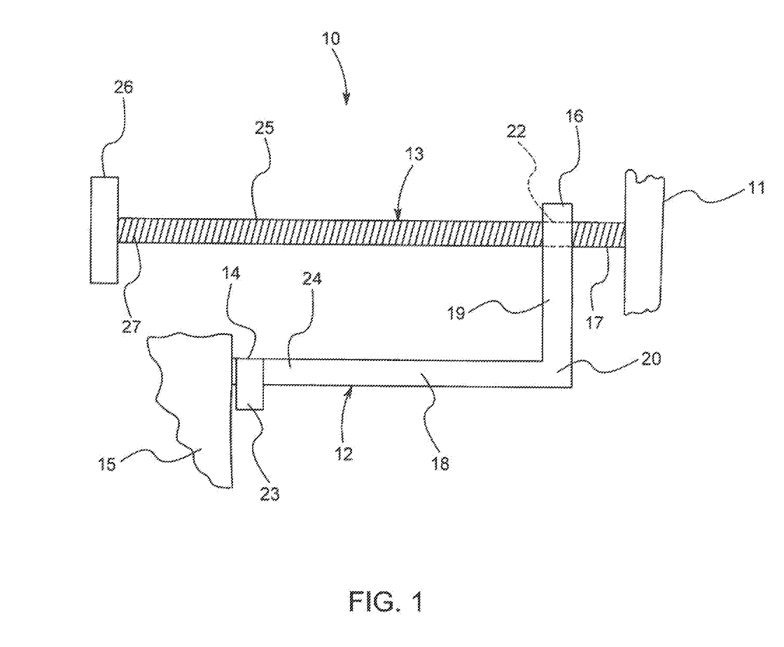

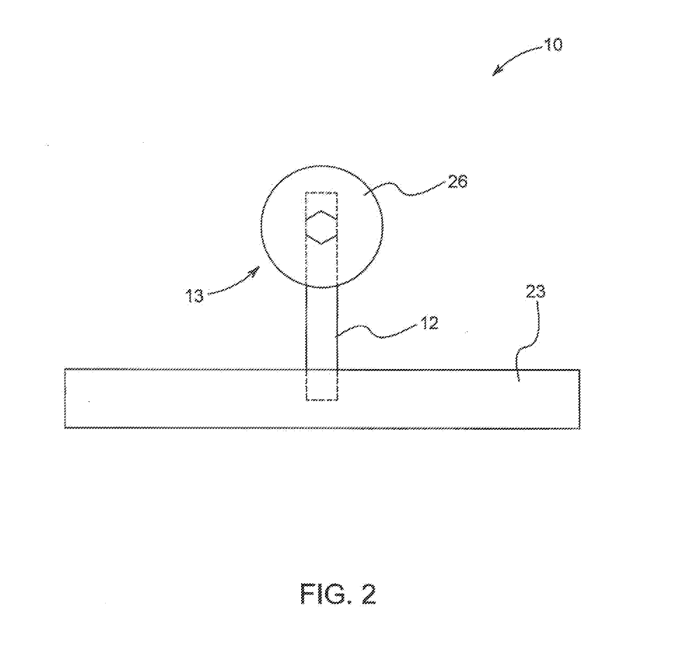

Referring to FIGS. 1 and 2 of the drawings, there is illustrated a tool 10 for removing a frozen brake rotor 11 from a wheel hub (not shown), according to an exemplary embodiment of the present general inventive concept. The frozen brake rotor removal tool 10 may include a right-angled bar 12 and an elongated bolt 13. The right-angled bar 12 may have one end 14 configured to rest against a stationary support bracket 15, normally used to support a caliper (not shown) of the automotive braking system, after the caliper is removed from the stationary support bracket 15. The elongated bolt 13 may be threaded through an opposite end 16 of the right-angled bar 12 to support the elongated bolt 13 laterally offset from the right-angled bar 12 and adjustably turnable relative to the opposite end 16 of the right-angled bar 12 to advance a leading end 17 of the elongated bolt 13 away from the opposite end 16 of the right-angled bar 12 in a direction away from the stationary support bracket 15 toward the brake rotor 11 so as to apply a force between the stationary support bracket 15 and the brake rotor 11 that pushes the brake rotor 11 to unfreeze and release or separate from the wheel hub.

The right-angled bar 12 of the tool 10 may have an elongated main portion 18 and an end portion 19 shorter than the elongated main portion 18. The end portion 19 may be rigidly affixed to and extending in a transverse relationship in one direction away from a first end 20 of the elongated main portion 18 at the opposite end 16 of the right-angled bar 12. The end portion 19 at its end 21 spaced from the first end 20 of the elongated main portion 18 may have a threaded hole 22 formed therethrough that threadably receives the elongated bolt 13. The right-angled bar 12 also may have a plate 23 rigidly affixed to and extending in a transverse relationship in another direction opposite to the one direction and away from a second end 24 of the elongated main portion 18 at the one end 14 of the right-angled bar 12. The plate 23 is configured to rest against the stationary support bracket 15.

The elongated bolt 13 of the tool 10 may have an elongated threaded stem portion 25 and a head portion 26 rigidly affixed to one end 27 of the elongated threaded stem portion 25 that receives a head of a wrench (not shown) used to turn the elongated bolt 13. The leading end 17 of the elongated threaded stem portion 25 of the elongated bolt 13 is opposite from the head portion 26 of the elongated bolt 13.

To start the process of pushing the brake rotor 11 off the wheel hub after the caliper and caliper bracket are removed, the transverse plate 23 on the right-angled bar 12 of the tool 10 is placed to rest against the stationary support bracket 15 and extend toward the brake rotor 11. Then using a suitable drive socket and ratchet wrench (not shown) the elongated bolt 13 is turned to place its leading end 17 into contact with the frozen brake rotor 11. Turning of the elongated bolt 13 is continued until the brake rotor 11 is pushed off the wheel hub. Turning the wheel hub may be necessary to repeat the process at different locations on the brake rotor 11 in order to complete the removal of the brake rotor 11 depending on the severity of the corrosion. While performing the process, the brake rotor 11 should be grasped by the free hand to prevent it from falling to the floor to ensure no damage occurs to the brake rotor. After freeing the brake rotor, the right-angled bar 12 of the tool 10 may be placed on an opposite end of the brake caliper piston (not shown) and by using the same wrench the piston may be repositioned to enable reinstalling new disc brakes over a replacement brake rotor once installed on the wheel hub.

The tool 10 may be fabricated from a durable material with stability, ensuring that it can endure the rotation pressures for safe and efficient operation. To produce a one-piece design of the right-angled bar 12 of the tool 10, a cast mold may be used to make it quick and easy to produce. Once the right-angled bar 12 is removed from the cast mold, the threaded hole 22 may be drilled out, such as for a ½ inch width elongated bolt 13.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A tool for removing a brake rotor frozen to a wheel hub, comprising:
a right-angled bar having one end configured to rest against a stationary support bracket for a caliper with the caliper removed from the stationary support bracket; and
an elongated bolt threaded through an opposite end of the right-angled bar to support the elongated bolt laterally offset from the right-angled bar and adjustably turnable relative to the opposite end of the right-angled bar to advance a leading end of the elongated bolt away from the opposite end of the right-angled bar in a direction away from the stationary support bracket toward the brake rotor so as to apply a force between the stationary support bracket and the brake rotor that pushes the brake rotor to separate from the wheel hub.

2. The tool of claim 1, wherein the right-angled bar has an elongated main portion and an end portion shorter than the elongated main portion and rigidly affixed to and extending in a transverse relationship in one direction away from a first end of the elongated main portion at the opposite end of the right-angled bar.

3. The tool of claim 2, wherein the right-angled bar also has a plate rigidly affixed to and extending in a transverse relationship in another direction opposite to the one direction and away from a second end of the elongated main portion at the one end of the right-angled bar, the plate being configured to rest against the stationary support bracket.

4. The tool of claim 2, wherein the end portion of the right-angled bar at an end thereof spaced from the first end of the elongated main portion of the right-angled bar has a threaded hole formed therethrough that threadably receives the elongated bolt.

5. The tool of claim 4, wherein the elongated bolt has an elongated threaded stem portion and a head portion rigidly affixed to one end of the elongated threaded stem portion that receives a head of a wrench used to turn the elongated bolt.
